(19) United States
(12) Patent Application Publication
(10) Pub. No.: US 2026/0159361 A1
(43) Pub. Date: Jun. 11, 2026

(54) FINGER GUARD

(71) Applicant: Konecranes Global Corporation, Hyvinkää (FI)

(72) Inventors: Mikko RITALA, Hyvinkää (FI); Juha AROLA, Hyvinkää (FI)

(21) Appl. No.: 18/706,479

(22) PCT Filed: Nov. 7, 2022
(86) PCT No.: PCT/FI2022/050730

§ 371 Date: May 1, 2024

(30) Foreign Application Priority Data
Nov. 8, 2021 (FI) U20214112

(51) Int. Cl. B66C 15/00; B66C 1/34; B66D 3/04

(52) U.S. Cl. CPC B66C 15/00; B66D 3/04; B66C 1/34; B66D 2700/026

(57) ABSTRACT

A finger guard arranged to at least partly surround a casing of a rope pulley of a hook block of a crane. Two slots are arranged in the finger guard, wherein each slot comprises a slot angle which is 35 to 120 degrees, when a vertex of the slot angle is the center point of the finger guard.

### BACKGROUND

The invention relates to a hook block of a crane and, in particular, to a finger guard placed over a casing of a rope pulley of the hook block.

The hook block of a rope hoist crane usually comprises two rope pulleys between which resides a hook of the crane for moving items. The rope pulley rotates with the rope movement when the hook block is being lifted or lowered. There is a safety risk between the rope pulley and hoisting rope when a user seeks to catch the hook block to guide the hook into the correct position. The user's finger may potentially find its way between the rope pulley and hoisting rope, in the worst case leading to serious damaging of the user's finger.

### BRIEF DISCLOSURE

An object of the invention is thus to provide an apparatus that solves the aforementioned problems. The object of the invention is achieved with a finger guard which is characterised by what is stated in the independent claim. Preferred embodiments of the invention are disclosed in the dependent claims.

The invention is based on a finger guard placed over a rope pulley. The finger guard allows free movement of the hoisting rope in the slots, but prevents a user's fingers from touching an area between the rope pulley and hoisting rope.

### BRIEF DESCRIPTION OF THE DRAWINGS

The invention will now be described in more detail in connection with preferred embodiments and with reference to the accompanying drawings, in which:

FIG. 1 illustrates a finger guard intended for attachment to a hook block;

FIG. 2 illustrates a cross sectional view of the finger guard attached over a casing of a rope pulley;

FIG. 3 illustrates an external view of the finger guard;

FIG. 4 illustrates an inside view of the finger guard;

FIG. 5 illustrates in more detail the point B shown in FIG. 4;

FIG. 6 illustrates in more detail the point C shown in FIG. 4.

### DETAILED DESCRIPTION OF EMBODIMENTS

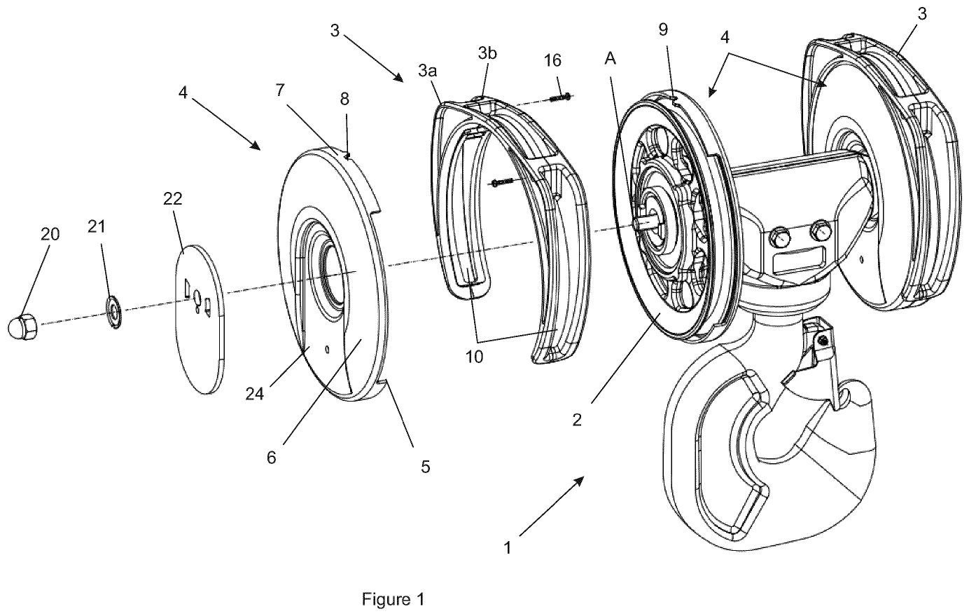

Referring to FIG. 1 which illustrates a hook block 1 comprising two rope pulleys 2 inside a casing 4, which have a common centre axis A. The hook is arranged at least partly in the area between two casings 4. Over the right-hand side casing 4 shown in FIG. 1, a finger guard 3 according to the invention has been installed. For the left rope pulley 2 in FIG. 1, a partial exploded view is shown on how the finger guard 3 is installable over the casing 4 of the rope pulley 2. FIG. 2 illustrates a cross sectional view with the finger guard 3 attached over the casing 4 of the rope pulley 2.

The rope pulley 2 is typically inside the casing 4 so that the casing 4 axially covers the entire rope pulley 2 and has the same centre axis A as the rope pulley 2 whereby the casing 4 may be detachably fastened to the centre axis A. The casing 4 may consist of two counterparts that are mutually identical. The counterpart may have a circular cover part 6 arranged to cover the rope pulley 2 entirely in the axial direction of the centre axis A. On the circumference of the casing 4 there may be at least one flange 7 arranged to at least partially cover the edge of the rope pulley 2 in the radial direction. To facilitate the opening and closing of the casing 4, there may be a nut 20 fixed to an end of the centre axis A, such as an acorn nut shown in FIG. 1. Between the nut 20 and casing 4 it is further possible to arrange a sealing ring 21 and/or an auxiliary plate 22 preventing the rotation of the casing 4 around the centre axis A. The cover part 6 of the casing 4 may be so shaped that it has at least one recess 24 of the size of the auxiliary plate 22.

The rope pulley 2 can rotate and the hoisting rope 11 can move freely inside the casing 4 without making contact with the casing 4. The counterparts of the casing 4 may be correctly aligned in the correct position with the aid of at least one protrusion 8 and corresponding at least one indentation 9 in the flange 7 of the casing 4. Part of the flange on the counterpart of the casing 4 may be narrower than the remaining flange 7, or part of the flange may be missing altogether, whereby the narrower or missing flange part, with the corresponding narrower or missing part of the counterpart, forms an opening 5 for the entry and exit of the hoisting rope 11.

The finger guard 3 may be formed of one piece, but the finger guard 3 shown in the accompanying drawings is formed of two opposite halves 3a, 3b which are mutually identical. Manufacturing the finger guard 3 of two pieces is easier production-wise and additionally provides a lighter solution.

Two longitudinal slots 10 are arranged in the finger guard 3 that allow free movement of the hoisting rope 11 when the hoisting block 1 is moving up and down. Therefore, the width of the slot 10 is larger than the thickness of the rope 11. The slot 10 prevents a user's fingers from being caught between the rope pulley 2 and hoisting rope 11. Each slot 10 comprises a slot angle α which is 35 to 120 degrees when a vertex of the slot angle α is the centre point K of the finger guard 3. More advantageously, the slot angle α is 45 to 100 degrees. In this context, slot angle α refers to the magnitude of the angle between the longitudinal ends of the slot 10, when the vertex is the centre point K of the finger guard and the first arm of the angle is the straight line connecting the first end of the slot 10 and the centre point K, and the second arm of the angle is the straight line connecting the second end of the slot 10 and the centre point K, whereby the first and second arms of the angle form the slot angle α whose magnitude is indicated in degrees. For example, a right angle is 90 degrees.

The slot 10 allows the hoisting rope 11 to move freely from the casing 4 and into the casing 4 while the rope pulley 2 is rotating inside the casing 4. The degree a of the slot 10 allows the angle of the hoisting rope 11 to vary. When the hook block 1 is at its lowest, the hoisting rope 11 is almost vertical. When the hook block 1 is at its highest, that is, close to the hoisting mechanism, the angle of the hoisting rope 11 differs from the vertical axis by approximately 35 degrees. Between the top part of the slot 10 and the almost vertical hoisting rope 11 a gap 12 of no more than 10 mm wide is left, which also prevents a user's finger from making contact with the rope pulley 2.

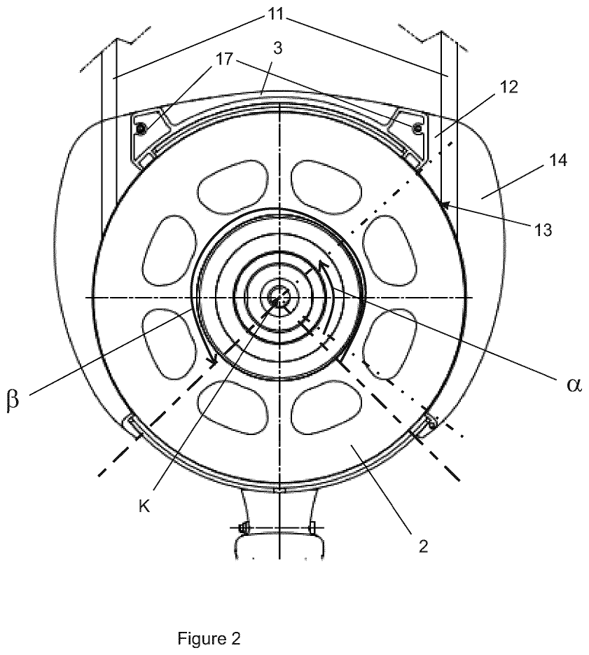

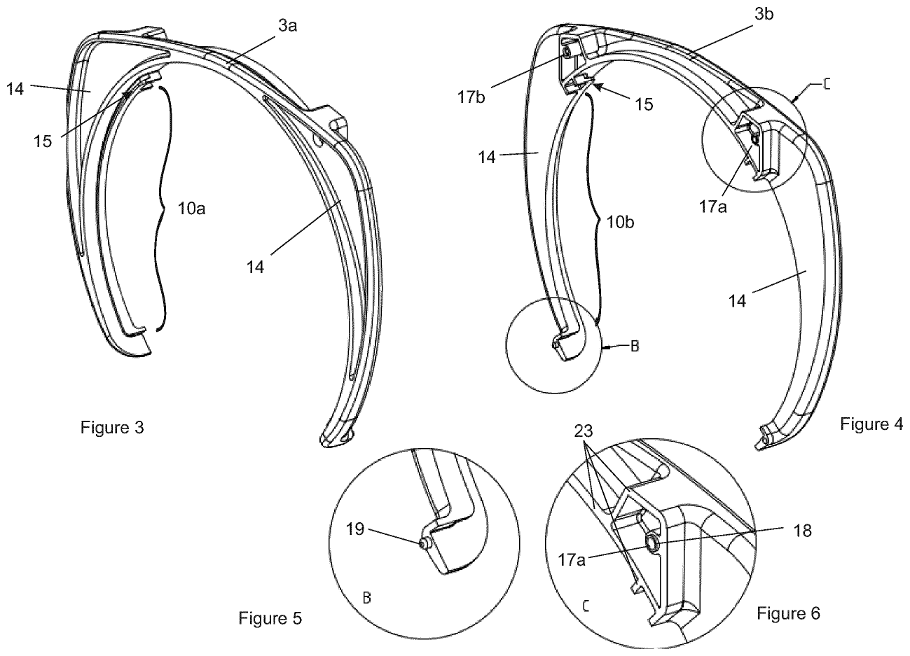

FIGS. 3 to 6 illustrate the finger guard 3 in closer detail. FIG. 3 shows an external view of a half 3a of the finger guard. FIG. 4 shows an internal view of a half 3b of the finger guard. FIG. 5 shows in more detail the point B shown in FIG. 4. FIG. 6 shows in more detail the point C shown in FIG. 4.

Each half 3a, 3b may comprise two recesses 10a, 10b which, when aligned, form two longitudinal slots 10 because the halves 3a, 3b are identical. The purpose of the slot 10 is to allow movement of the hoisting rope 11 out of the casing 4 or into the casing 4 between the halves 3a, 3b. On both sides of the longitudinal direction of the slot 10 there may be a protrusion 14 which protrudes in the radial direction in relation to the centre axis A, helping to keep the safety distance adequate. The EN ISO 13857 standard, for example, shows how to pursue the reduction of the risk of danger by a safety distance. With the help of the protrusions 14, the adequate safety distances referred to in the standard may be achieved.

The height of the protrusions 14 may be irregular, so that in the radial direction of the central axis A from the slot 10 to the highest point of the protrusion 14 is not constant. The highest point of the protrusion 14 may be at the point where the hoisting rope 11 differs by 0 to 9 degrees from a vertical hoisting rope 11. This means that the highest point of the protrusion 14 may be on the upper third of the longitudinal direction of the slot 10, from where the height of the protrusion 14 decreases towards the bottom part of the slot 10. Therefore, the protrusion 14 provides an adequate safety distance according to the standard from the junction 13 of the rope pulley 2 and hoisting rope 11 to the upper part of the protrusion 14 when the hoisting rope 11 is nearly vertical. The goal is to keep the gap 12 between the upper end of the slot 10 and the almost vertical hoisting rope 11 smaller than 10 mm. If the gap 12 exceeds 10 mm, the need arises to extend the safety distance whereby the finger guard 3 becomes considerably larger. The protrusions 14 may be advantageously mutually parallel, and the space between them is larger than the thickness of the hoisting rope 11.

The finger guard 3 according to the invention may surround the casing 4 of the rope pulley 2 of the hook block 1 over the distance of the angle β which is more than 250 degrees when a vertex is the centre point K of the finger guard 3. The angle β may be more advantageously 270 to 290 degrees. In this context, angle β refers to the magnitude of the angle between the longitudinal ends of the finger guard 3 over the entire length of the finger guard 3 when the vertex is the centre point K of the finger guard and the first arm of the angle β is the straight line connecting the first end of the finger guard 3 and the centre point K, and the second arm is the straight line connecting the second end of the finger guard 3 and the centre point K, whereby the arms of the angle form the degree β. In some embodiments, the finger guard 3 may entirely surround the casing 4 of the rope pulley 2, in which case the angle β is 360 degrees. The larger degree of the angle β provides a good form locking and prevents the finger guard 3 from tilting and bending in relation to the casing 4, but as concerns the safety distance, an angle exceeding 250 degrees is enough.

The outer edge of the slot 10 may form a shoulder 15 protruding away from the slot 10 and arranged to fasten to the casing 4 of the rope pulley 2 of the hook block 1 or to prevent the finger guard from rotating in relation to the casing 4 of the rope pulley 2 of the hook block 1, or both. The shoulder 15 is advantageously integrated into part of the finger guard 3. The shoulder 15 is arranged to be fastened on the inside of the opening 5 in the casing 4 over its entire length or at least partly over the length of the opening 5. The shoulder 15 may be adapted to the form of the opening 5 in the casing 4 whereby extra fasteners are not needed but the shoulder 15 keeps the finger guard 3 in place when the casing 4 is closed, that is, the counterparts are interconnected. However, the shoulder 15 does not touch the rope pulley 2 or hoisting rope 11. The shoulder 15 prevents axial movement of the finger guard 3 and at the same time limits the rotation of the finger guard 3 by +/−1 degree. Rotation to some extent may be allowed, because the lengths of the openings 5 in the casing 4 may vary within the manufacturing tolerances of the casing 4.

The finger guard 3 according to the drawings is formed of two identical halves 3a, 3b which may be connected to each other with screws 16 or with other fasteners, connectors, clamps, or glue. The screws 16 ensure that the halves 3a, 3b are rigidly fastened to each other and do not move in relation to each other. Alignment members 18 are arranged to align the halves 3a, 3b in the correct position. Due to the halves 3a, 3b being identical, there is an even number of alignment members 18, whereby the alignment members 18 are on one side and the receiving members 19 are on the other sider of the imaginary vertical centre line. At a fastening hole 17a of the screw 16 there may be an alignment member 18 aligned to an opening 17b in the opposite half, the opening 17b being arranged to receive the alignment member 18 therein. The fastening points 17 for the screws 16 may be arranged over the slots 10. In addition, below the slots 10 there may be second alignment member/receiving member pairs 18, 19 which align the opposite half with the corresponding receiving member/alignment member points 19, 18 of the opposite half. The alignment members 18 (or alternatively receiving members 19) below the slot 10 ensure that the finger guard 3 has enough support area in each direction.

The halves 3a, 3b may also comprise additional support surfaces or support parts 23. These support surfaces or support parts 23 may be advantageously located near the alignment members 18 in the upper part of the halves and at least partly in the area between the alignment members 18. The support surfaces or support parts 23 likewise provide more rigidity and support for the finger guard 3.

Even though the finger guard 3 disclosed in the description and drawings is made of two halves 3a, 3b, the inventive finger guard 3 may also be manufactured of one complete part.

The finger guard 3 may be made of plastics, and advantageously of acrylonitrile butadiene styrene plastic (ABS), which possesses good machinability, surface quality, and chemical resistance. It is an adequately stiff material that keeps its form and can withstand shocks well.

The finger guard 3 according to the invention also allows retrofitting on casings 4 of a rope pulley 2 of a hook block 1 already in use, so a user need not acquire an entirely new casing of a rope pulley.

1. A finger guard arranged to attach over and at least partly surround a casing of a rope pulley of a hook block of a crane, wherein two slots are arranged in the finger guard, wherein each slot comprises a slot angle which is 35 to 120 degrees, wherein a vertex of the slot angle is the centre point of the finger guard, and
a shoulder protrudes from an outer of slot which is arranged to prevent the finger guard from rotating in relation to the casing.

2. The finger guard as claimed in claim 1, wherein the slot angle is 45 degrees to 100 degrees.

3. The finger guard as claimed in claim 1, wherein on both sides of longitudinal direction of the slot there is a protrusion which protrudes in the radial direction in relation to the central axis and having a height which is irregular.

4. The finger guard as claimed in claim 1, wherein the finger guard is arranged to surround the casing of the rope pulley of the hook block over the distance of the angle which is more than 250 degrees, wherein a vertex of the angle is the center point of the finger guard.

5. The finger guard as claimed in claim 4, wherein the angle is 270 degrees to 290 degrees.

6. The finger guard as claimed in claim 1, wherein the shoulder is arranged to fasten to the casing of the rope pulley of the hook block.

7. The finger guard as claimed in claim 6, wherein the shoulder is integrated into a part of the finger guard.

8. The finger guard as claimed in claim 6, wherein the shoulder is arranged to be fastened on an inside of an opening in the casing over its entire length or at least partly over the length of the opening.

9. The finger guard as claimed in claim 1, wherein the finger guard consists of two identical halves.

10. The finger guard as claimed in claim 9, wherein alignment members are arranged to align the halves in a correct position.

11. The finger guard as claimed in claim 9, wherein fastening points for screws are arranged over the slots.

12. The finger guard as claimed in claim 10, wherein the halves further comprise additional support surfaces or support parts which are located at least partly in the area between the alignment members.
